(19) United States
(12) Patent Application Publication
(10) Pub. No.: US 2012/0112461 A1
(43) Pub. Date: May 10, 2012

(54) DUAL USE FAN ASSEMBLY FOR HVAC SYSTEMS AND AUTOMOTIVE SYSTEMS TO GENERATE CLEAN ALTERNATIVE ELECRIC ENERGY

(75) Inventor: Raymond Saluccio, Colonia, NJ (US)

(73) Assignee: Earth Sure Renewable Energy Corporation, Woodbridge, NJ (US)

(21) Appl. No.: 13/333,633

(22) Filed: Dec. 21, 2011

(51) Int. Cl. F03D 9/02; F03D 9/00

(52) U.S. Cl. 290/50; 290/55

(57) ABSTRACT

A new energy production system 10 is provided having a dual use fan assembly 60 including a plurality of fan blades 62, 64, 66, 68 having fan blade tips; a series of rotating permanent magnets 30 are mounted within an inner rotating ring 90 connected to the rotating fan blade tips; and a series of stationary stators 40 are mounted within an outer surrounding cover or shroud 100, which is fixed and does not rotate; to produce a magnetic field to produce a green alternative energy source. This occurs while the fan assembly 60 also simultaneously operates as a fan to create air flow used for cooling in other industries, such as cooling of HVAC exhaust air, and such as cooling of a radiator in an automotive use, and as a computer fan.

### FIELD OF THE INVENTION

This invention relates to a dual purpose HVAC exhaust fan assembly that has the ability to exhaust warm air from AC units, while it simultaneously creates clean alternative electric energy. The dual use fan assembly of the present invention can also be used to produce electric energy in automotive systems while cooling the radiator. The fan assembly is driven by an electrical motor or a mechanical automotive motor that drive the rotation of the fan.

### BACKGROUND OF THE INVENTION

Mechanical electrical fans and their motors are utilized in various industries such as HVAC, automotive, computers, as well as others for the purpose of movement of air. The fast moving circular motion of the fan blades in combination with the circular shroud or cover that accompanies it creates an opportunity to create alternative clean electric energy. This new energy production is achieved by utilizing a system of magnets and stators surrounding the outer radius of the unified connected fan blades creating an outer shroud or track. These series of magnets and stators are incorporated in the surrounding an outer shroud or track of the unified fan assembly to generate electric energy as the fan rotates for their purpose of air movement.

### OBJECTS OF THE PRESENT INVENTION

An object of the present invention is to provide clean electrical power by using a uniquely designed duel use fan system that performs as a common motorized fan, while also producing electric energy at the same time.

Another object of the present invention is to provide a duel use fan system that creates electricity. The outer stationary shroud or track houses the stator coils and surrounds the outer edges of the fan blades. An inner rotating track or ring houses a series of permanent magnets, and the inner rotating track is connected to the outer edges of the rotating fan blades, and they rotate together relative to the outer stationary track to produce energy. This occurs while the fan blades are also operating as a common fan for the original purpose of air movement around the fan.

Another object of the present invention is to provide energy that is created on the outer edges of the fan blades, so there is no mechanical obstruction within the interior of the fan assembly that is commonly associated with power generation that use mechanical gear boxes.

Another object of the present invention is to provide a system that eliminates the need of mechanical gear boxes so that there is no interference with the fan blades as they rotate to produce the movement of air. Thus, the present invention for using fans to produce electric energy, does not impede the common use of fans for air movement.

Another object of the present invention is to provide the power generated from this dual use fan system so that it can be stored by various energy storage devices. The stored energy can be accessed at any time in order to be sent to a power grid, and then sent from the grid to a facility that needs electric energy.

Another object of the present invention is to utilize the dual use fan assembly to produce electric energy, and send it to send it to the power grid in order to offset energy consumption and utility bills.

Another object of the present invention is to provide a dual use fan system which produces clean electric energy in large amounts while still performing its normal function in an HVAC system or in a automotive system that use fans for air movement.

Another object of the present invention is to provide in the automotive application a dual use fan system which produces electrical energy, and therefore the alternator can be eliminated. The available power created by using this invention is sent back to the power grid via V2G (vehicle to grid technology).

Another object of the present invention is to provide a dual use fan system in place of a computer fan, which will produce electric energy while it is being used as a computer fan.

### SUMMARY OF THE INVENTION

A new energy production system 10 is provided having a dual use fan assembly 60 including a plurality of fan blades 62, 64, 66, 68 having fan blade tips 62a, 64a, 66a, 68a; a series of permanent magnets 30 are mounted within an inner rotating ring 90 connected to the rotating fan blade tips; and a series of stators 40 are mounted within an outer surrounding cover or shroud 100, which is fixed and does not rotate. The series of permanent magnets 30 include side by side permanent magnets 32, 34, 36, 38. The stators 40 include a series of stator coils 42, 44, 46, 48. In this manner, the series of rotating permanent magnets and the series of fixed stator coils rotate relative to each other and produce a magnetic field to produce a green alternative energy source. This occurs while the fan assembly 60 also simultaneously operates as a fan to create air flow used for cooling in other industries, such as cooling of HVAC exhaust air, and such as cooling of a radiator in an automotive use, and as a computer fan.

The power generation occurs at the unified fan blade tips 62a, 64a, 66a, 68a which creates an outer energy ring 100 during energy production. The dual use fan assembly 20 uses no gears for energy production, and the energy output of the fan assembly can be increased by increasing the number of stator coils 40 or the number of aligned magnets 30 that surround the outer edge of the blades dual fan assembly 20. The rotation of the fan assembly 20 relative to the outer shroud or cover 100 produces electrical energy which is collected by collector wires 80 disposed within collector 82 which is connected to a junction box or invertor 90 and storage batteries 92 and 94 which store the electrical energy produced.

### BRIEF DESCRIPTION OF THE DRAWINGS

FIG. 1 is a front view of the duel use fan assembly of the present invention;

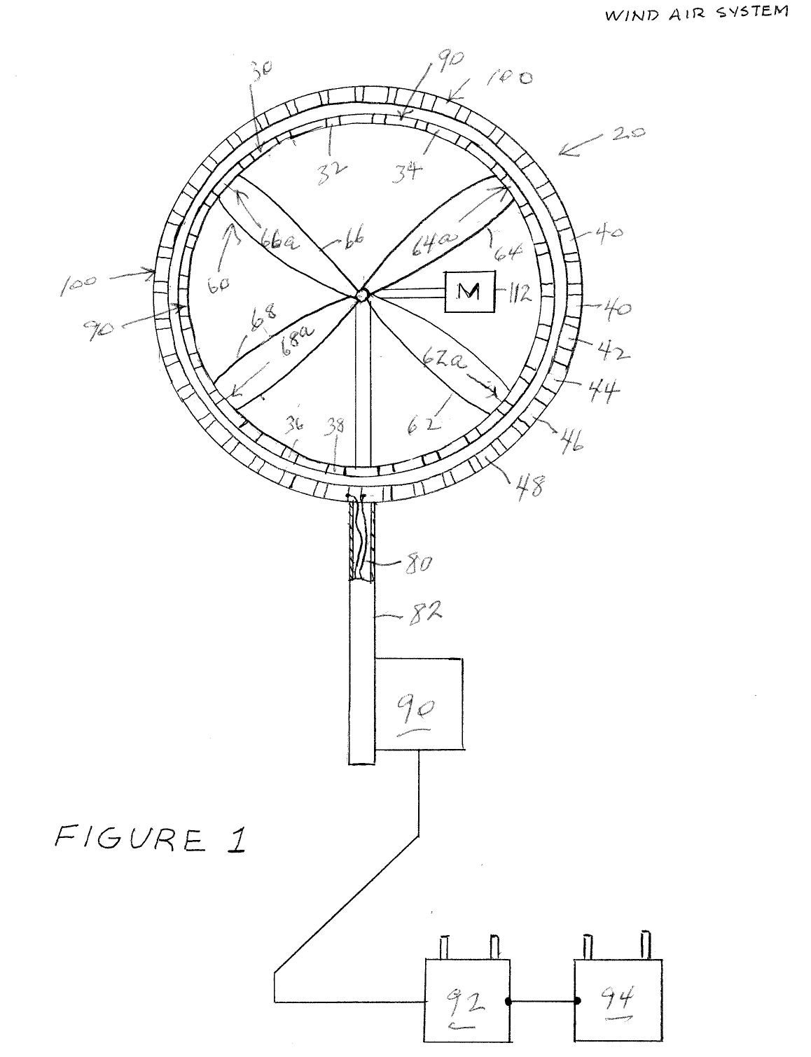

FIG. 2 is a side view of the duel use fan assembly of the present invention, as used in an automotive application;

FIG. 3 is a front view of the duel use fan assembly of the present invention, as used in an HVAC system; and

FIG. 4 is a top view of the motor driving the inner rotating ring.

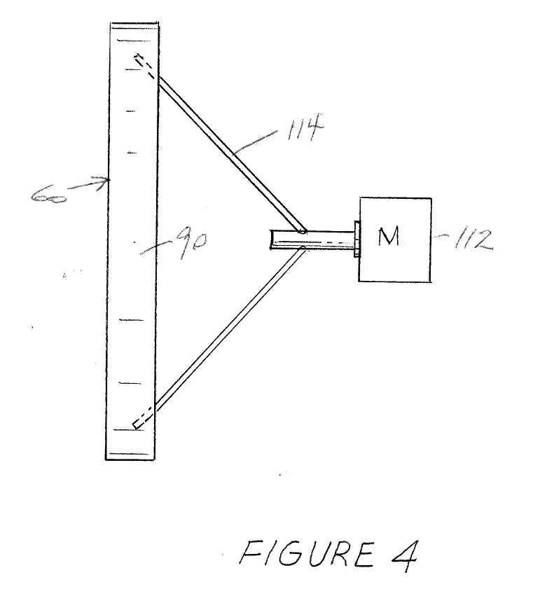

### DETAILED DESCRIPTION OF THE PREFERRED EMBODIMENT

A new energy production system 10 is provided having a dual use fan assembly 60 including a plurality of fan blades 62, 64, 66, 68 having fan blade tips 62a, 64a, 66a, 68a; a series of permanent magnets 30 are mounted within an inner rotating ring 90 connected to the rotating fan blade tips; and a series of stators 40 are mounted within an outer surrounding cover or shroud 100, which is fixed and does not rotate. The series of permanent magnets 30 include side by side permanent magnets 32, 34, 36, 38. The stators 40 include a series of stator coils 42, 44, 46, 48. The motor 112 which rotates the fan blades, also operates to rotate the permanent magnets 30 which are mounted within the rotating ring 90 at the tips of the rotating fan blades.

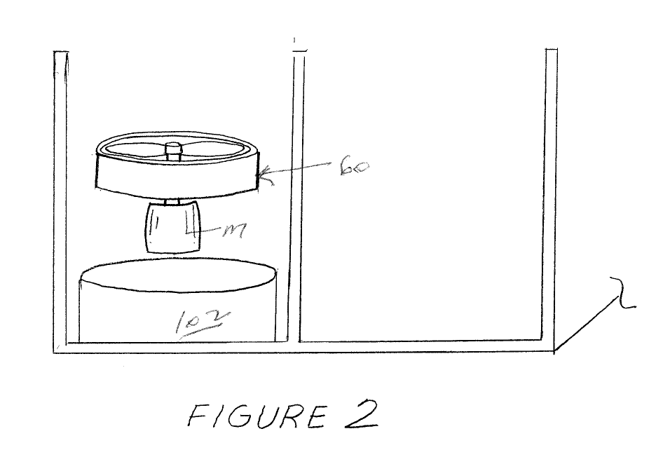

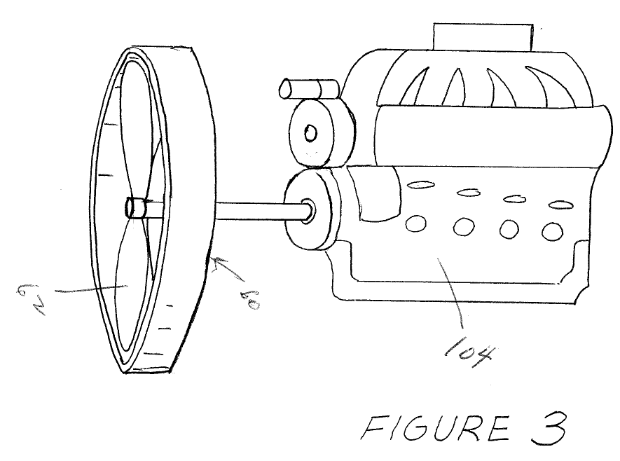

In this manner, the series of rotating permanent magnets 32, 34, 36, 38 and the series of fixed stator coils 42, 44, 46, 48 rotate relative to each other and produce a magnetic field to produce a green alternative energy source. This occurs while the fan assembly 60 also simultaneously operates as a fan to create air flow used for cooling in other industries, such as cooling of exhaust air of an HVAC system 102 (see FIG. 2), and such as cooling the exhaust air of a radiator in an automotive engine 104 (see FIG. 3), and such as a computer fan for cooling.

By utilizing permanent magnets 30 it avoids the use of bearings, which have to be greased or maintained. By using magnets 30 instead of bearings, there is no wear and tear created, since a magnetic field is produced by the rotating magnets 30 within the dual use fan assembly 20. The power generation that occurs at edges of the unified fan blade tips 62a, 64a, 66a, 68a and at the outer cover or shroud 100 creates an energy producing rotating ring 100, which is a gearless type generator because it lacks gears for movement during energy production. This gearless dual use fan assembly 20 used for energy production can be increased by increasing the amount of stator coils 40 and the amount of aligned magnets 30 that surround the dual fan assembly 20.

The rotation of the fan assembly 20 produces electrical energy which is collected by electrical collector wires 80 within a surrounding tube 82 which is connected to a junction box 90 and storage batteries 92 and 94 which store the electrical energy that has been produced.

In addition, the inner rotating ring 90, which creates the magnetic power as a result of its rotation relative to the outer stationary cover 100, may have an alternative construction. The rotating ring 90 maybe attached directly to the shaft of the motor 112 using a plurality of metal spokes that are connected at the inner end to the rotating motor shaft and at the other end to the rotating ring 90. These plurality of spokes are rotated by the motor shaft to rotate the inner ring 90 independently of the rotating fan blades. In addition, the spokes to drive the inner ring can be attached to a front shaft of the motor 112 or to a rear shaft of the motor 112.

### ADVANTAGES OF THE PRESENT INVENTION

An advantage of the present invention is to provide clean electrical power by using a uniquely designed duel use fan system that performs as a common fan, while also producing electric energy at the same time.

An advantage of the present invention is to provide a duel use fan system that creates electricity. The outer stationary shroud or track houses the stator coils and surrounds the outer edges of the fan blades. An inner rotating track or ring houses a series of permanent magnets, and the inner rotating track is connected to the outer edges of the rotating fan blades, and they rotate together relative to the outer stationary track to produce energy. This occurs while the fan blades are also operating as a common fan for the original purpose of air movement around the fan.

An advantage of the present invention is to provide energy that is created on the perimeter edges of the fan blades, so there is no mechanical obstruction within the interior of the fan assembly that is commonly associated with power generation that use mechanical gear boxes.

An advantage of the present invention is to provide a system that eliminates the need of mechanical gear boxes so that there is no interference with the fan blades as they rotate to produce the movement of air. Thus, the present invention for using fans to produce electric energy, does not impede the common use of fans for air movement.

An advantage of the present invention is to provide the power generated from this dual use fan system so that it can be stored by various energy storage devices. The stored energy can be accessed at any time in order to be sent to a power grid, and then sent from the grid to a facility that needs electric energy.

An advantage of the present invention is to utilize the duel use fan assembly to produce electric energy, and send it to send it to the power grid in order to offset energy consumption and utility bills.

An advantage of the present invention is to provide a duel use fan system which produces clean electric energy in large amounts while still performing its normal function in an HVAC system or in a automotive system that use fans for air movement.

Another advantage of the present invention is to provide in the automotive application a dual use fan system which produces electrical energy, and therefore the alternator can be eliminated. The available power created by using this invention is sent back to the power grid via V2G (vehicle to grid technology).

Another advantage of the present invention is to provide a dual use fan system in place of a computer fan, which will produce electric energy while it is being used as a computer fan.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed:

1) A new energy production system 10 using a dual use fan assembly, comprising:
a) a fan assembly 60 including a plurality of fan blades 62, 64, 66, 68 having fan blade tips 62a, 64a, 66a, 68a;
b) a series of permanent magnets 30 are mounted within an inner rotating ring 90 connected to the rotating fan blade tips, so that they rotate together;
c) a series of stators 40 are mounted within an outer surrounding cover or shroud 100, which is fixed an does not rotate;
d) said fan blade tips 62a, 64a, 66a, 68a of said fan blade assembly 60 and said series of permanent magnets 30 mounted in said inner rotating ring 90 all rotate together relative to said series of stators 40 within said outer cover or shroud 100;
e) said series of magnets 30 include side by side permanent magnets 32, 34, 36, 38, and said stators 40 include a series of stator coils 42, 44, 46, 48, so that said series of rotating magnets and said series of rotating stator coils rotate relative to each other and produce a magnetic field to produce a green alternative energy source, while the fan assembly 60 also simultaneously operates to create air flow used for cooling in other industries, such as cooling of HVAC exhaust air, and such as cooling of a radiator in an automotive use, and such as cooling for a computer fan.

2) A new energy production system 10 in accordance with claim 1, wherein said power generation occurs at the unified fan blade tips 62a, 64a, 66a, 68a which creates an inner energy ring 90 which rotates relative to the outer cover or shroud 100 for energy production.

3) A new energy production system 10 in accordance with claim 1, wherein said dual use fan assembly 20 uses no gears for energy production, and the energy output of said fan assembly is increased by increasing the number of stator coils 40 and the number of aligned magnets 30.

4) A new energy production system 10 in accordance with claim 1, wherein said rotation of said fan assembly 20 produces electrical energy which is collected by wires 80 within tube 82 which is connected to an inverter or a junction box 90 and which is connected to storage batteries 92 and 94 or any other electrical storage device for storing said electrical energy produced for future energy use to offset peak energy charges to consumers.
